(19) United States
(12) Patent Application Publication
(10) Pub. No.: US 2023/0204796 A1
(43) Pub. Date: Jun. 29, 2023

(54) DGNSS/RTK BASE STATION POSITION BIAS DETECTION AND CALCULATION

(71) Applicant: QUALCOMM Incorporated, San Diego, CA (US)

(72) Inventors: Min WANG, Tustin, CA (US); Ning LUO, Cupertino, CA (US); Yinghua YANG, San Jose, CA (US); Ling HAN, Shanghai (CN)

(21) Appl. No.: 18/001,056

(22) PCT Filed: Aug. 20, 2020
(86) PCT No.: PCT/CN2020/110140

§ 371 Date: Dec. 7, 2022

(51) Int. Cl. G01S 19/41; G01S 19/07

(52) U.S. Cl. CPC G01S 19/41; G01S 19/071

(57) ABSTRACT

Global Navigation Satellite System (GNSS) receivers can provide more accurate positioning when augmented using Real-Time Kinematic (RTK) or Differential GNSS (DGNSS) corrections. Techniques described herein leverage multi-constellation, multi-frequency (MCMF) measurements taken at a base station at first and second times to generate correction information that can be used to detect and correct a bias (or offset) in the location of the base station. This bias may be detected by a rover station, or by the base station itself.

### BACKGROUND

### 1. Field of Invention

The present invention relates to generally to the field of satellite-based positioning, and more specifically to error correction of Global Navigation Satellite System (GNSS) terms for more accurate position determination.

### 2. Description of Related Art

High-accuracy positioning can provide significant value to various modern-day applications for mobile devices. For example, not only is it helpful to have meter-level positioning to determine the lane of the road in which a vehicle is located for autonomous driving applications, it is further helpful to have sub-meter-level positioning to determine where, within the lane, the vehicle is located. Consumer-grade GNSS receivers now offer quality carrier phase measurements, with multi-constellation, multi-frequency (MCMF) functionality.

### BRIEF SUMMARY

Global Navigation Satellite System (GNSS) receivers can provide more accurate positioning when augmented using Real-Time Kinematic (RTK) or Differential GNSS (DGNSS) corrections. Techniques described herein leverage multi-constellation, multi-frequency (MCMF) measurements taken at a base station at first and second times to generate correction information that can be used to detect and correct a bias (or offset) in the location of the base station. This bias may be detected by a rover station, or by the base station itself.

### BRIEF DESCRIPTION OF THE DRAWINGS

FIG. 1 is a simplified diagram of a satellite-based differential positioning system, according to an embodiment.

FIGS. 2-3 is an illustration of an overhead view of an autonomous driving application for position determination.

FIG. 4 is a flowchart of an embodiment of a method for determining base station bias.

FIG. 5 is a graph of simulated results in which the accuracy of a base station bias determination, in the manner described herein, is plotted over time.

FIG. 6 is a flow diagram of a method of determining a bias in a location of a base station of a satellite-based differential positioning system, according to an embodiment.

FIG. 7 is a block diagram of various hardware and software components of a rover station, according to an embodiment.

FIG. 8 is a block diagram of various hardware and software components of a base station, according to an embodiment.

FIG. 9 is a block diagram of various hardware and software components of a computer system, according to an embodiment

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

As used herein, the terms “rover station” and “mobile device” and variants thereof are often used interchangeably. Broadly speaking, the rover station or mobile device may comprise an electronic device and may be referred to as a device, a mobile device, a wireless device, a mobile terminal, or the like. As such, the rover station or mobile device may correspond to a cellphone, smartphone, laptop, tablet, personal data assistant (PDA), tracking device, wearable device, Internet of Things (IoT) device, or some other portable or moveable device. (It can be noted, however, embodiments of a rover station are not necessarily limited to mobile applications.) The rover station may include a single entity or may include multiple entities such as in a personal area network where a user may employ audio, video and/or data I/O devices and/or body sensors and a separate wireline or wireless modem. In some cases, a rover station or mobile device may be part of some other entity—e.g. may be a chipset supporting a modem that is integrated into some larger mobile entity such as a vehicle, drone, package, shipment, robotic device etc. In some embodiments, the rover station or mobile device may comprise a mobile phone or other device that can support wireless communication under the 5G NR standard, and/or one or more additional Radio Access Technologies (RATs) such as Global System for Mobile communication (GSM), Code Division Multiple Access (CDMA), Wideband CDMA (WCDMA), Long Tenn Evolution (LTE), High Rate Packet Data (HRPD), IEEE 802.11 Wi-Fi, Bluetooth® (BT), Worldwide Interoperability for Microwave Access (WiMAX), etc. The rover station or mobile device may also support wireless communication using a Wireless Local Area Network (WLAN). Moreover, the rover station or mobile device may be capable of using any or all of these wireless technologies to connect to public or private data communication networks (e.g., the Internet).

As used herein, the terms “position” and “location” are used interchangeably. Further, terms such as “position determination,” “position fix,” “location estimate,” and the like are also used interchangeably herein with regard to GNSS-based positioning to refer to an estimated position of a rover station (or mobile device) comprising a GNSS receiver. An estimate of a location of the rover station may be geodetic, thus providing location coordinates for the rover station (e.g., latitude and longitude) which may or may not include an altitude component (e.g., height above sea level, height above or depth below ground level, floor level or basement level). In some embodiments, the coordinate frame in which coordinates are provided may comprise an East, North, Up (ENU) coordinate frame, although different coordinate frames may be used in different applications.

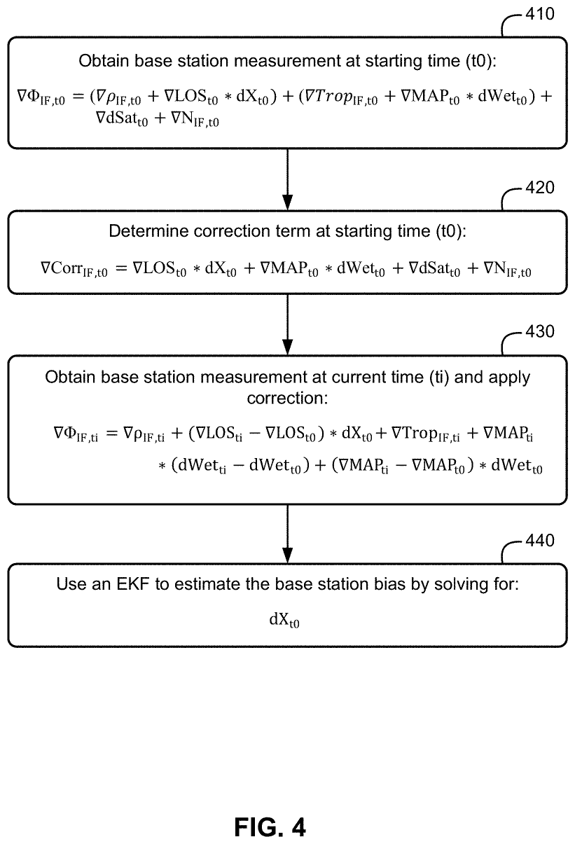

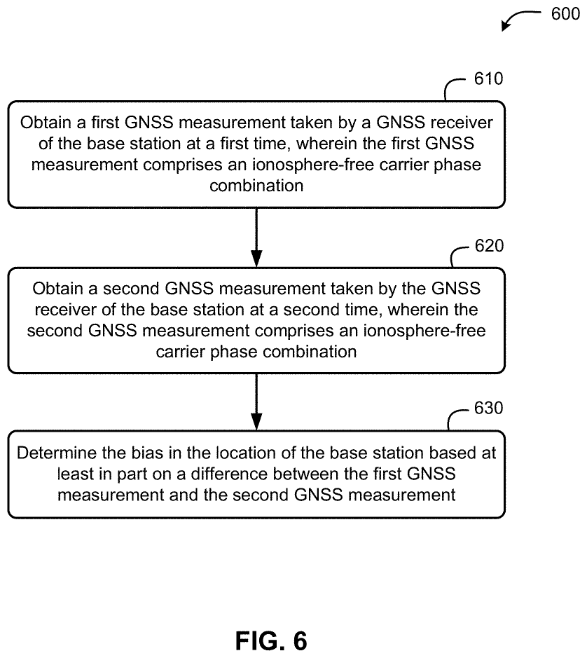

Additionally, although described as being performed by a rover station, base station (also known as a reference station), or service provider server (or similar server), the techniques provided herein for base station bias determination are not so limited. For example, a 5G NR network may include a variety of devices connected therewith, capable of obtaining measurement data from a base station (as described herein, e.g., with regard to FIGS. 4 and 6) in determining the base station bias. In such instances, this determination may be forwarded (e.g., directly or indirectly, via directed or broadcast signaling) to a rover station and/or other devices. Additionally or alternatively, such devices may be capable of performing some aspects of the base station bias determination, while other devices described herein (e.g., the rover station) perform other aspects. Further, although described herein as a determination of base station bias for correcting rover station position fix is based thereon, applications are not so limited. For example, applications may include determining an accurate location of a fixed device (e.g., a base station), which may be used for precise positioning.

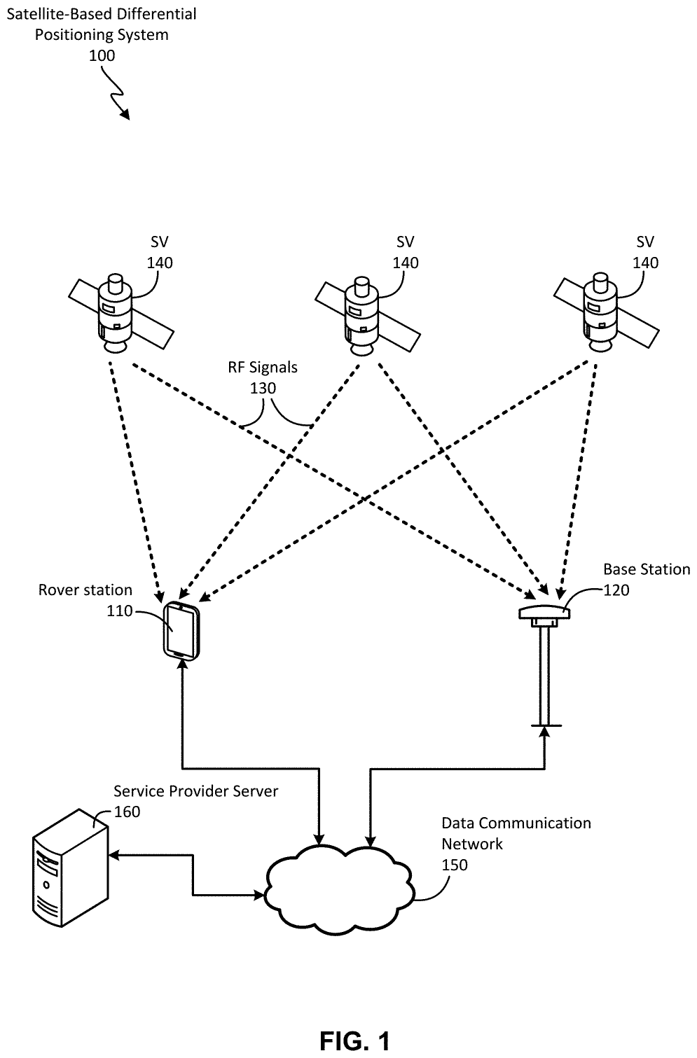

FIG. 1 is a simplified diagram of a satellite-based differential positioning system 100, which can be used to provide Real-Time Kinematic (RTK) or Differential GNSS (DGNSS) corrections to a rover station 110, enabling the rover station 110 to achieve a more accurate GNSS-based position fix than traditional GNSS techniques. In particular, the satellite-based differential positioning system 100 enables a highly accurate GNSS position fix of the rover station 110 by using GNSS receivers at both the rover station 110 and base station 120 that receive RF signals 130 from satellite vehicles (SVs) 140 from one or more GNSS constellations (e.g., Global Position System (GPS), Galileo (GAL), GLObal NAvigation Satellite System (GLONASS), Beidou, Indian Regional Navigational Satellite System (IRNSS), Quasi-Zenith Satellite System (QZSS), etc.). As previously noted, types of rover stations 110 used may vary, depending on application, and may include any of a variety of types of mobile devices having access to GNSS positioning data, such as mobile devices equipped with GNSS receivers.

For simplicity, the diagram shown in FIG. 1 shows only a single rover station 110, base station 120, data communication network 150, and service provider server 160, as well as three SVs 140. In practice, however, a satellite-based differential positioning system 100 may comprise dozens or hundreds of SVs 140 that, as noted, may be part of a plurality of GNSS constellations. Additionally or alternatively, the satellite-based differential positioning system 100 can have any number of base stations 120 (dozens, hundreds, etc.). Some embodiments, for example, may have a large network of geographically-dispersed base stations 120 communicatively coupled with the data communication network 150 and managed by a service provider. The service provider may include one or more service provider servers 160 capable of collecting information provided by base stations 120 and sending the information to the rover station 110. This process may include the service provider server(s) 160 identifying a relevant base station 120 (e.g. a base station 120 closest to the rover station 110) from which to send information to the rover station 110. Further, the satellite-based differential positioning system 100 may be capable of servicing any number of rover stations 110 (e.g., dozens, hundreds, thousands, millions, etc.).

The data communication network 150 may comprise one or more public and/or private networks (e.g., the Internet) capable of communicating data from the base station 120 to the rover station 110. Arrows from the rover station 110 and base station 120 to the data communication network 150 represent communication links, which can include one or more intervening devices and/or networks capable of relaying information to and from the data communication network 150. The rover station 110 and base station 120 can communicate with the data communication network 150 using wired and/or wireless communication technologies, such as the wireless communication technologies previously listed.

To perform a traditional GNSS position fix, the rover station 110 can use code-based positioning to determine a distance of each of the SVs 140 based on a determined delay in a generated pseudorandom binary sequence received in the RF signals 130. The resulting accuracy of the position fix for the rover station 110 is subject to errors caused by SV 140 orbit and clock, ionosphere and troposphere delays, and other phenomena. Traditional GNSS position fixes can provide an accuracy on the order of meters, which may be less than desirable for many applications.

DGNSS is a differential positioning technology in which a more accurate position fix for the rover station 110 can be determined by accounting for differences in measurements made by the rover station 110 and the base station 120. In DGNSS, the rover station 110 performs code-based ranging based on the RF signals 130 in a manner similar to traditional GNSS, but also uses the base station 120 to make similar measurements from a known reference location that can be used to make differential corrections of errors from various error sources, such as orbit and clock errors, ionosphere and troposphere delays, etc. To do so, “service data” comprising the measurements taken by the base station 120 and the base station's known location is provided to the rover station 110 to make the differential corrections. This service data may be provided to the rover station 110 via, for example, a data communication network 150. DGNSS position fixes can provide an accuracy on the order of a meter to submeter.

RTK positioning can provide an even higher accuracy solution by using carrier-based ranging based on the carrier wave of the RF signals 130 and using the base station 120 to make similar observations from a reference location that, similar to DGNSS, can be used to make differential corrections of errors from various error sources. In RTK, however, the service data communicated to the rover station 110 further allows the rover station to use differential carrier phrase between the base and client device to determine a highly-accurate position fix. RTK position fixes can provide an accuracy on the order of several centimeters or decimeters.

The position fix for the rover station 110 (using either DGNSS or RTK) relies on the known position of the base station 120, which is included in the service data sent to the rover station 110. As such, any bias (inaccuracy) in the position of a base station 120 can carry over to a bias in the position fix for the rover station 110. Because the location of the base station 120 is fixed, its location is typically determined upon initial configuration and conveyed as the “known location” of the base station 120 in all subsequent service data related to the base station 120. (In some embodiments, the location of the base station 120 may be stored by a database maintained by the service provider server 160.) Thus, if the location of a base station 120 is inaccurate, position fixes all the rover station 110 that rely on service data from the base station 120 are also inaccurate.

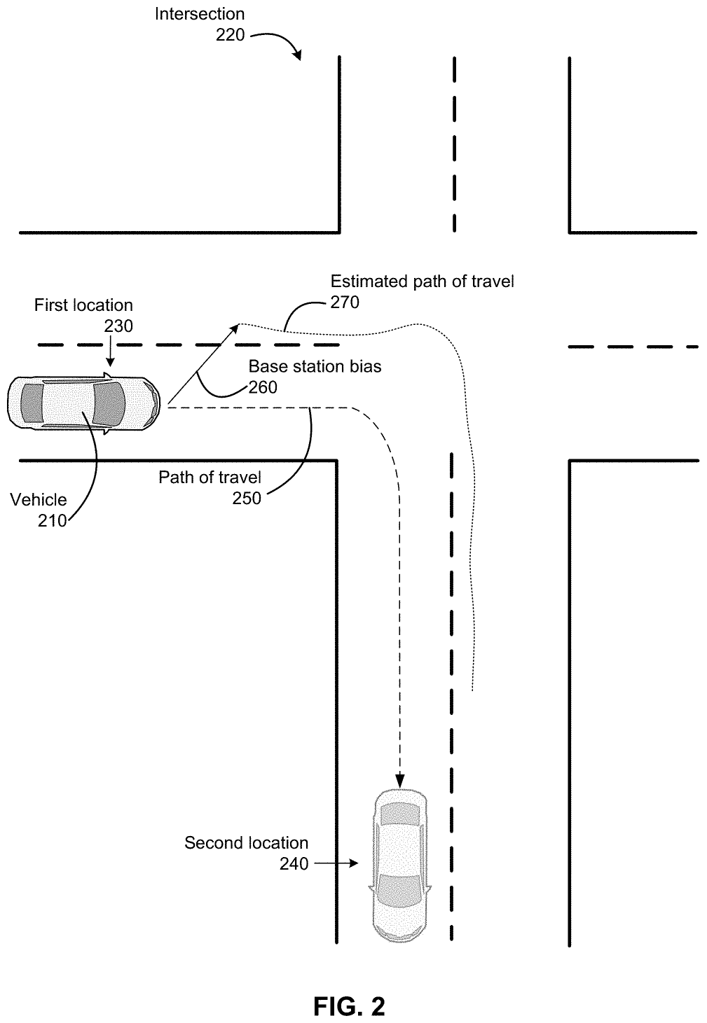

Such base station bias, if undetected, can be highly problematic in many applications. FIG. 2 is an illustration of an overhead view of one such application: autonomous driving. In this example, an autonomous vehicle 210 travels through an intersection 220 from a first location 230 to a second location 240 along a path of travel 250. Autonomous driving levels L2 or greater, for example, often require decimeter-level accuracy. And thus, DGNSS or RTK positioning techniques may be used to determine an accurate location in real time for the vehicle 210 (acting as a rover station 110).

Problematically, however, the service data provided to the vehicle 210 comprises a base station bias 260. Thus, despite the accuracy that DGNSS or RTK positioning techniques what otherwise provide the vehicle 210, position fixes for the vehicle 210 are offset by the base station bias 260, resulting in an estimated path of travel 270 that is far less accurate than needed for autonomous driving. As can be seen, the estimated path of travel 270 would place the vehicle 210 in different lanes (or even off the road, in other circumstances) due to the base station bias 260, which may be several meters in some instances. An autonomous vehicle following the path of travel 270 in only a short travel distance could be subject to multiple accidents.

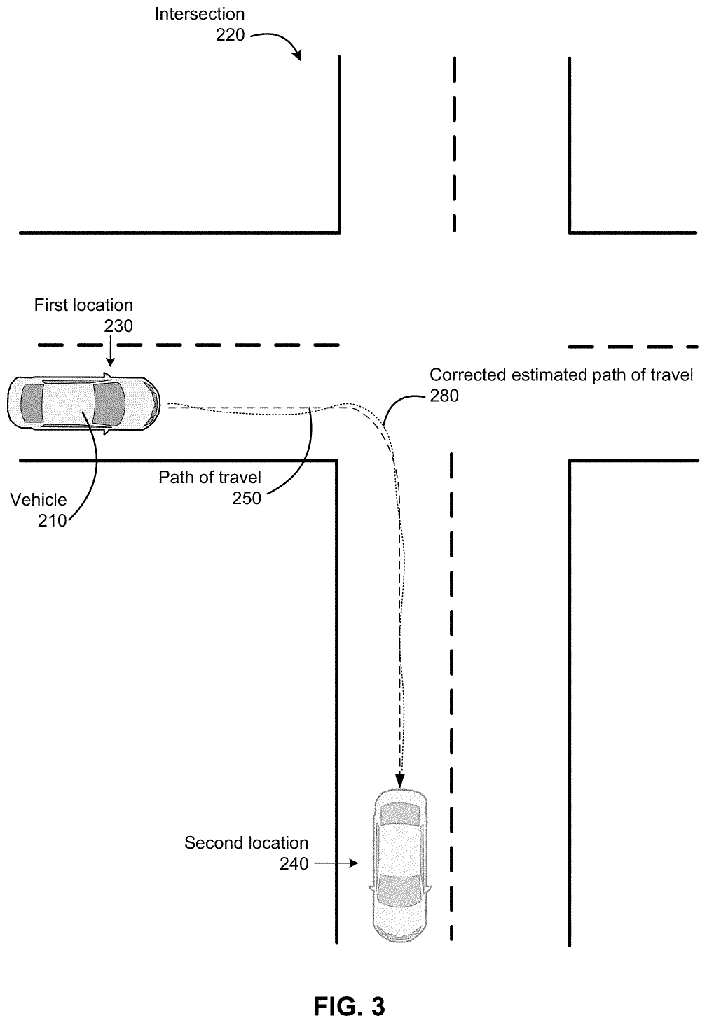

FIG. 3 is an illustration of an overhead view of the same conditions as FIG. 2. However, the base station bias 260 (of FIG. 2) has been removed, resulting in a corrected estimated path of travel 280 that is far more accurate than the estimated path of travel 270 of FIG. 2. As can be seen, by reducing or removing the base station bias 260, the resulting positioning of the vehicle 210 using DGNSS or RTK is much more closer to the highly-accurate positioning capabilities of DGNSS or RTK. This can be on the order of decimeters or even centimeters, and therefore can be used in automated driving and other applications.

Embodiments provided herein directed toward reducing or removing the base station bias 260. To do so, techniques can leverage multi-constellation, multi-frequency (MCMF) measurements taken at the base station 120 at first and second times to generate correction information that can identify a bias in the location of the base station 120 at, for example, a decimeter level. Different techniques can be employed to detect and (optionally) correct the bias. This detection and/or correction can be done in real-time, according to some embodiments.

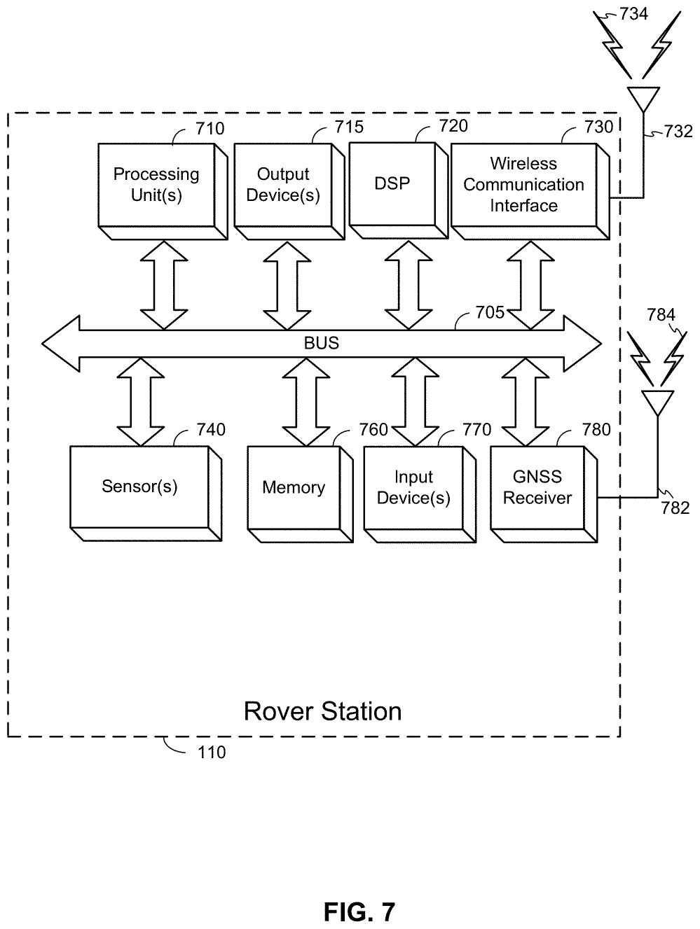

FIG. 4 is a flowchart of an embodiment of a method for determining base station bias, in which functions are described mathematically. The functionality in each of the blocks illustrated in FIG. 4 may be performed by hardware and/or software components of a computing device, such as the rover station 110, base station 120, or service provider server 160. (Example hardware and software components of example computing devices are provided in FIGS. 7-9, which are described below.) It can be noted that, although the embodiment described in FIG. 4 includes specific terms and equations, alternative embodiments may use alternative terms and/or equations in a similar manner.

At block 410 initial base station measurements at a starting time are obtained, t0. As noted, this functionality can be performed by a rover station 110, base station 120, or service provider server 160 (or other computing device). Because this measurement is taken in the normal course of obtaining and providing service data, this information can be easily obtained by the rover station 110 (which receives the measurement in the service data), base station 120 (which takes the measurement), or service provider server 160 (which may relay the service data with the measurements to the rover station 110).

As noted in block 410, measurement at the starting time (t0) can be represented as:

∇Φ_{IF,t0}=(∇ρ_{IF,t0}+∇LOSₜ₀*dXₜ₀)+(∇Trop_{IF,t0}+∇MAPₜ₀*dWetₜ₀)+(∇dSatₜ₀+∇N_{IF,t0}, (1)

where equation variables are defined as follows:
∇—Between satellite single-differencing operator
Φ_{IF}—Ionosphere-free carrier phase combination (e.g., from combinations of GPS L1, L2, and L5 carriers; GAL E1, E5A, E5B, and E6 carriers; and/or BDS B11, B1C, B2A, B2B, and B3 carriers)
ρ—Calculated geometry range
LOS—Satellite line-of-sight vector
dX—Position error vector to be estimated
Trop—Calculated troposphere delay using models
MAP—Troposphere wet component mapping function
Wet—Troposphere wet zenith delay error to be estimated
Sat—Satellite orbit and clock combined error
N—Ambiguity term for ionosphere-free carrier phase combination.

In this embodiment, ionosphere errors may not need to be accounted for in equation (1) because ionosphere errors can be reduced using the ionosphere cancellation functionality of the MCMF GNSS receiver. More specifically, when GNSS signals pass through the ionosphere layers, ionospheric refraction will occur. However, the first order impact (99.9%) of errors arising from this refraction is inversely proportional to the square of the signal frequency. Therefore when at least two signals with different frequencies from the same satellite are available, this first order impact can be eliminated in MCMF receivers that can detect these signals by taking a measurement that uses a combination of the signals, namely ionosphere-free carrier phase combination, Φ_{IF} (A similar ionosphere-free combination is valid for pseudorange measurements.) In this manner, the MCMF GNSS receiver can take a measurement of a plurality of RF signals 130 (shown in FIG. 1) transmitted on different frequencies (e.g., GPS L1 and L5 frequencies, GAL E1 and E5A frequencies, BDS B1I and B2A frequencies, etc.) that accounts for ionospheric delay. That said, alternative embodiments may utilize receivers that do not provide ionosphere-free observations in this matter, and may instead account for ionosphere-related errors by estimating ionosphere delays at starting time tO and subsequently at time ti.

At block 420 a GNSS correction term is determined that corresponds to the starting time (t0). As will be seen, this can be applied against a subsequent measurement to provide correction and determine a bias in the base station location. The correction term can be calculated as follows:

∇Corr_{IF,t0}=∇Φ_{IF,t0}−∇ρ_{IF,t0}−∇Trop_{IF,t0} (2)

As shown in block 420, this correction term can also be represented as:

∇Corr_{IF,t0}=∇LOSₜ₀*dXₜ₀+∇MAPₜ₀dWetₜ₀+∇dSatₜ₀+∇N_{IF,t0} (3)

At block 430 a base station measurement at a “current time” (ti) can be obtained, in a manner similar to the manner in which the measurement at block 410 was obtained. This measurement can be represented as:

∇Φ_{IF,ti}=(∇ρ_{IF,ti}+∇LOSₜᵢ*dXₜᵢ)+(∇Trop_{IF,ti}+∇MAPₜᵢdWetₜᵢ)+∇dSatₜᵢ+∇N_{IF,ti·} (4)

The correction can then be applied to the measurement of block 430 by taking the difference of the terms in equations (3) and (4). Because ∇dSatₜᵢ≈∇dSatₜ₀ and ∇N_{IF,ti}=∇N_{IF,t0}, the resulting measurement at current time ti, after correction is applied, can be represented as follows:

∇Φ_{IF,ti}=∇ρ_{IF,ti}+∇LOSₜᵢ*(dXₜᵢ−dXₜ₀)+(∇LOSₜᵢ−∇LOSₜ₀)*dXₜ₀+∇Trop_{IF,ti}+∇MAPₜᵢ*(dWetₜᵢ−dWetₜ₀)+(∇MAPₜᵢ−∇MAPₜ₀)*dWetₜ₀ (5)

However, because the location of the base station 120 has not changed, dXₜᵢ=dXₜ₀. And thus, equation (5) can be further reduced to:

∇Φ_{IF,ti}=∇ρ_{IF,ti}+(∇LOSₜᵢ−∇LOSₜ₀)*dXₜ₀+∇Trop_{IF,ti}+∇MAPₜᵢ*(dWetₜᵢ−dWetₜ₀)+(∇MAPₜᵢ−∇MAPₜ₀)*dWetₜ₀ (6)

as illustrated at block 440 of FIG. 4.

With this corrected term of equation (6), an Extended Kalman Filter (EKF) (or similar filter) can be used to accurately estimate the base station bias by solving for dXₜ₀.

The process illustrated in FIG. 4 can be done in real time, where determinations at blocks 420 and 440 are executed by a positioning engine (e.g., a positioning engine based on an EKF or other filter, such as Weighted Least Squares (WLS), a hatch filter, particle filter, or the like executed by the rover station 110, base station 120, or service provider server 160). The length of time between the starting time (t0) and current time (ti) to obtain an accurate estimate of the base station bias may vary, depending on desired functionality.

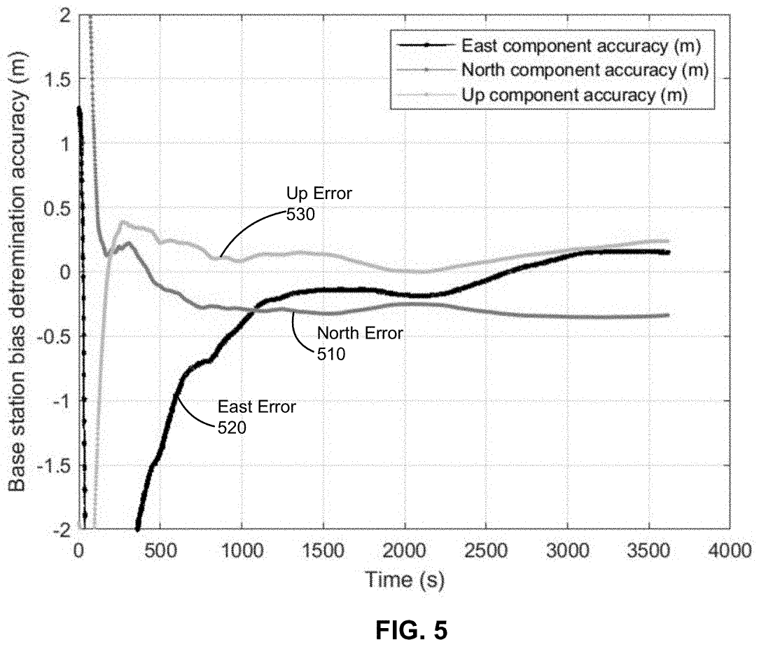

FIG. 5, for example, is a graph of simulated results in which the accuracy of components of base station bias estimation (north error 510, east error 520, and up error 530) is plotted over time. The simulation extended 3600 seconds (60 minutes). As can be seen, accuracy—especially horizontal accuracy—improves over time, initially exceeding 2 m and eventually dropping and remaining below 50 cm at around 900 seconds (15 minutes). Thus, according to some embodiments, the measurement obtained at block 430, may exceed 900 seconds (e.g., 20 minutes, 25 minutes, 30 minutes, etc.) to help ensure an accurate base station bias determination. In applications in which accuracy is not as important, embodiments may utilize a shorter time period (e.g., 15 minutes, 12 minutes, etc.) Thus, the embodiments provided herein can be used to detect and optionally correct base station biases using only GNSS measurements taken at the base station 120. These biases can be reduced from several meters to less than 1 m (e.g., few decimeters, or even a few centimeters). As noted, this can be particularly useful in applications requiring a high level of accuracy, such as autonomous driving (e.g. as shown in FIGS. 2 and 3).

Different courses of action can be taken upon the determination of the base station bias, which may be dependent on application. For example, a detected base station bias on the order of decimeters may be ignored in some applications, requiring meter-level accuracy or higher. Thus, the base station bias may be compared with a threshold value to determine whether or not to take action, where the threshold value is determined based on the application. Alternatively, some applications may require the highest possible degree of accuracy, and therefore action may be taken if any biases detected. (As seen in FIG. 5, there may be a minimum bias determination accuracy, and thus, a detected bias could be compared against this minimum accuracy.) For example, in high-level accuracy applications, such as RTK position fixes, action may be taken if any bias over 50 cm is detected. For DGNSS position fixes, action may be taken if a bias over 1 m is detected. Alternative embodiments and/or applications may have different bias thresholds.

According to some embodiments, a notification can be sent upon the detection of a base station bias over a minimum threshold. That is, the device estimating the base station bias (e.g., rover station 110, service provider server 160, or base station 120) can notify other devices. A rover station 110, for example, can notify the mobile data provider or other location provider, which may relay this notification to other rover stations 110 and/or otherwise prevent other rover stations from determining a position fixed based on information from the base station 120 having the detected bias. Additionally or alternatively, the device estimating the base station bias may notify the service provider (e.g., via the service provider server 160), allowing the service provider to take corrective measures to remove the bias. (One such corrective measure could include, for example, calculating the base station bias using the method of FIG. 4.)

In some embodiments, the estimated base station bias (dXₜ₀) can be used to make corrections. That is, a rover station 110 may use the base station bias (which it may have calculated, or received from another rover station, base station 120, or service provider server 160) to correct a position fix of the rover station 110 based on service data in that includes the base station bias. Moreover, the base station bias (along with an identifier of the base station 120) can be provided to a mobile data provider or other location provider and propagated to other rover stations to similarly compensate for base station bias. Additionally or alternatively, the service provider server 160 can use the base station bias to correct the stored value of the “known location” for the base station 120, such that subsequent service data for the base station 120 provided to rover stations has a corrected known location for the base station 120.

FIG. 6 is a flow diagram of a method 600 of determining a bias in a location of a base station of a satellite-based differential positioning system, according to an embodiment. The method 600 can utilize the techniques described above, and therefore may be seen as an implementation of the previously-described process, illustrated in FIG. 4. Alternative embodiments may vary in function by combining, separating, or otherwise varying the functionality described in the blocks illustrated in FIG. 6. According to some embodiments, the functionality is described in the blocks illustrated in FIG. 6 may be performed by a rover station 110, base station 120, or service provider server 160. As such, means for performing the functionality of one or more of the blocks illustrated in FIG. 6 may comprise hardware and/or software components illustrated in the hardware block diagrams of FIGS. 7-9, which are described in more detail below.

At block 610, the functionality comprises obtaining a first GNSS measurement taken by a GNSS receiver of the base station at a first time, where the first GNSS measurement comprises an ionosphere-free carrier phase combination. The ionosphere-free carrier phase combination may take the form of equation (1). To obtain an ionosphere-free carrier phase combination, measurements may be taken by an MCMF receiver at the base station. As illustrated at block 420 and described above, the ionosphere-free carrier phase combination may be used to create a correction term (e.g., represented as equation (2) or (3)). That said, it can be noted that the correction term may not be generated explicitly. Instead, it may be generated implicitly when at least some portions of the ionosphere-free carrier phase combination taken at the first time are used for differential correction of an ionosphere-free carrier phase combination taken at a subsequent time. In some embodiments, the ionosphere-free carrier phase combination may be included in or derived from service data conveyed in part from the base station to a rover station.

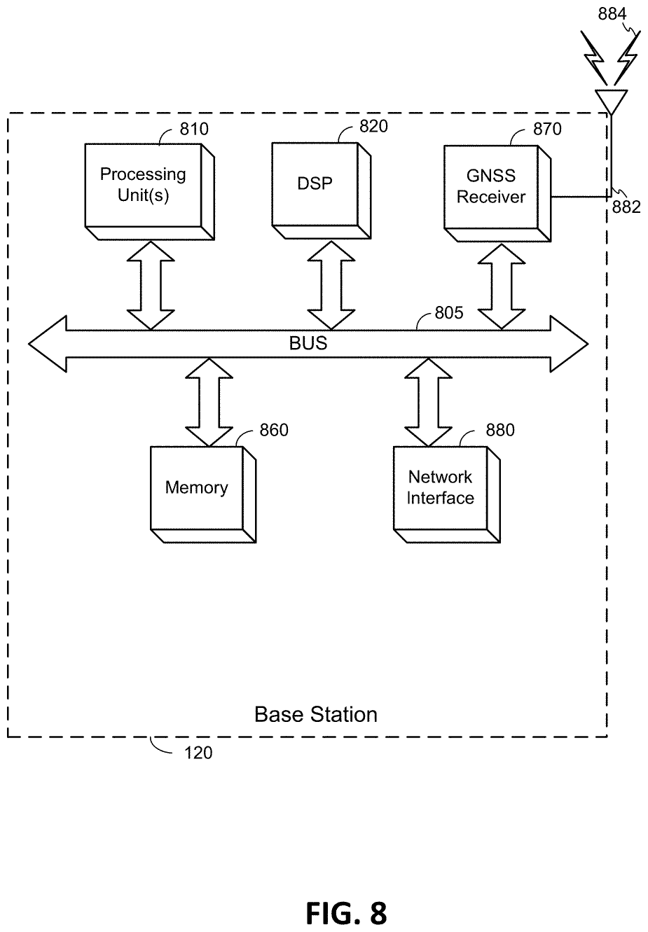

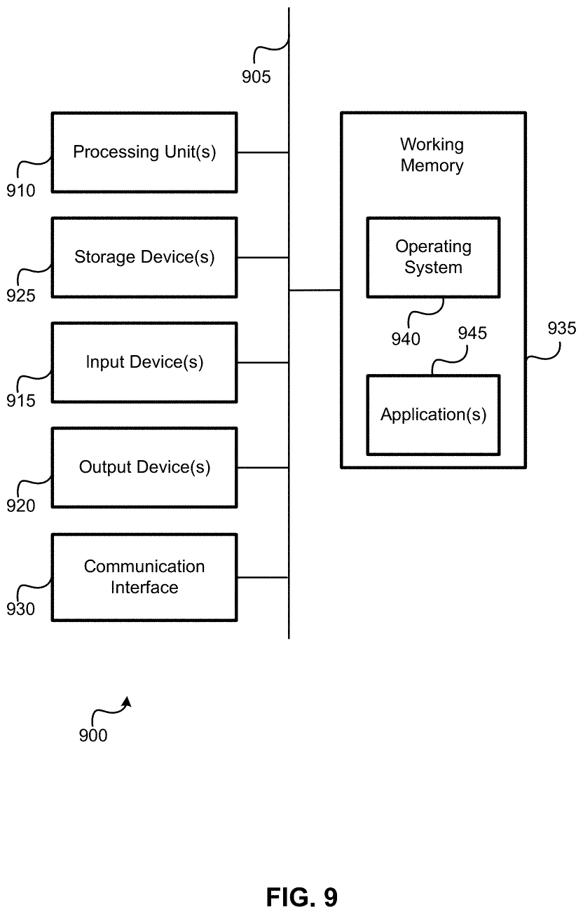

If the functionality at block 610 is executed by a rover station 110, means for performing the functionality may comprise a bus 705, processing unit(s) 710, wireless communication interface 730, memory 760, and/or other software and/or hardware components of a rover station 110 as illustrated in FIG. 6. If the functionality at block 610 is executed by a base station 120, means for performing the functionality may comprise a bus 805, processing unit(s) 810, GNSS receiver 870, memory 860, and/or other software and/or hardware components of a base station 120 as illustrated in FIG. 8. Finally, if the functionality at block 610 is executed by a service provider server 160 or other computer system, means for performing the functionality may comprise a bus 905, processing unit(s) 910, communications subsystem 930, working memory 935, application(s) 945, and/or other software and/or hardware components of a base station 120 as illustrated in FIG. 9.

At block 620, the functionality comprises obtaining a second GNSS measurement taken by the GNSS receiver of the base station at a second time, wherein the second GNSS measurement comprises an ionosphere-free carrier phase combination. As indicated in the above-described embodiments, a length of time between when the first GNSS measurement is taken in when the second GNSS measurement is taken may vary, depending on desired functionality. In some embodiments, this time maybe 15 minutes or greater.

If the functionality at block 620 is executed by a rover station 110, means for performing the functionality may comprise a bus 705, processing unit(s) 710, wireless communication interface 730, memory 760, and/or other software and/or hardware components of a rover station 110 as illustrated in FIG. 6. If the functionality at block 620 is executed by a base station 120, means for performing the functionality may comprise a bus 805, processing unit(s) 810, GNSS receiver 870, memory 860, and/or other software and/or hardware components of a base station 120 as illustrated in FIG. 8. Finally, if the functionality at block 620 is executed by a service provider server 160 or other computer system, means for performing the functionality may comprise a bus 905, processing unit(s) 910, communications subsystem 930, working memory 935, application(s) 945, and/or other software and/or hardware components of a base station 120 as illustrated in FIG. 9.

The functionality at block 630 comprises determining the bias in the location of the base station, based at least in part on a difference between the first GNSS measurement in the second GNSS measurement. As discussed in relation to FIG. 4, this determination may be made by taking the difference of like terms in the first and second ionosphere-free carrier phase combinations, which can be further simplified by equating the base station bias taken at the first time with the base station bias taken at the second time, as shown in equation (6) above. In some embodiments, additional correction terms can be applied, as previously indicated. For example, in some embodiments a between-satellite single difference may be conducted to obtain one or more correction terms for one or more errors in the first GNSS measurement, the second GNSS measurement, or both, related to receiver clock, GNSS inter/intra frequency and constellation biases, or receiver phase center variation effect, or any combination thereof. Determining the bias in the location of the base station may then be further based at least in part on the one or more correction terms.

If the functionality at block 630 is executed by a rover station 110, means for performing the functionality may comprise a bus 705, processing unit(s) 710, memory 760, and/or other software and/or hardware components of a rover station 110 as illustrated in FIG. 6. If the functionality at block 630 is executed by a base station 120, means for performing the functionality may comprise a bus 805, processing unit(s) 810, memory 860, and/or other software and/or hardware components of a base station 120 as illustrated in FIG. 8. Finally, if the functionality at block 630 is executed by a service provider server 160 or other computer system, means for performing the functionality may comprise a bus 905, processing unit(s) 910, working memory 935, application(s) 945, and/or other software and/or hardware components of a base station 120 as illustrated in FIG. 9.

As noted, embodiments may have additional properties, based on desired functionality. As noted, the method may be performed by the base station, a rover station, or a server (e.g., computer server or other computer system). The base station bias may be used for position fix correction. Thus, in some embodiments, the method 600 may comprise adjusting a GNSS position fix of a rover station, based at least in part on the determined bias in the location of the base station, where the GNSS position fix of the rover station is based on service data from the base station. As noted, service data from the base station can include the measurements from the base station (including first and/or second GNSS measurements taken at block 610 and/or 620), as well as a known location of the base station. In some embodiments, this location may be obtained by a service provider, which can create the service data for the rover station by retrieving the measurements from the base station, obtaining a corresponding known location for the base station, and sending the measurements and known location as service data to a rover station. Depending on desired functionality, the service data may comprise RTK service data or DGNSS service data.

Because the method 600 may be performed by the base station, a rover station, or a server (e.g., executed by a computer system), embodiments may additionally comprise providing information indicative of the determined bias to another device. This can be done, for example, via direct communication (e.g., a rover station communicating directly with the base station) and/or indirect communication (e.g., a rover station or base station communicating with a service provider server via the Internet). The information indicative of the determined bias may comprise the determined bias itself, or may comprise information derived from the bias, such as a corrected position of the base station.

For embodiments in which the method 600 is performed by a server, the server can operated by different types of entities. According to some embodiments, for example, the server may be operated by a manufacturer of the rover station, a provider of RTK services (which may also operate base stations 120), a wireless carrier, or a third party (e.g., a provider of crowdsourcing, navigation, and/or Internet services). Additionally or alternatively, a plurality of servers may be configured to collectively or individually perform one or more of the blocks illustrated in FIG. 6, and/or receive a determined bias in the location of a base station from another device (e.g., another server, a base station, rover station, etc.).

FIG. 7 is a block diagram of various hardware and software components of a rover station 110, according to an embodiment. These components can be utilized as described herein above (e.g. in association with FIGS. 1-6). For example, the rover station 110 can perform the actions of the rover station 110 illustrated in FIG. 1, the vehicle 210 illustrated in FIGS. 2 and 3, the methods of FIGS. 4 and 6, and/or similar functions. It should be noted that FIG. 7 is meant only to provide a generalized illustration of various components, any or all of which may be utilized as appropriate. As previously noted, rover stations 110 may vary in form and function, and may ultimately comprise any GNSS-enabled device, including vehicles, commercial and consumer electronic devices, survey equipment, and more. Thus, in some instances, components illustrated by FIG. 7 can be localized to a single physical device and/or distributed among various networked devices, which may be disposed at different physical locations (e.g., different locations of a vehicle).

The rover station 110 is shown comprising hardware elements that can be electrically coupled via a bus 705 (or may otherwise be in communication, as appropriate). The hardware elements may include a processing unit(s) 710 which can include without limitation one or more general-purpose processors, one or more special-purpose processors (such as digital signal processing (DSP) chips, graphics acceleration units (GPUs), application specific integrated circuits (ASICs), and/or the like), and/or other processing structure or means. As shown in FIG. 7, some embodiments may have a separate Digital Signal Processor (DSP) 720, depending on desired functionality. Location determination and/or other determinations based on wireless communication may be provided in the processing unit(s) 710 and/or wireless communication interface 730 (discussed below). The rover station 110 also can include one or more input devices 770, which can include without limitation a keyboard, touch screen, a touch pad, microphone, button(s), dial(s), switch(es), and/or the like; and one or more output devices 715, which can include without limitation a display, light emitting diode (LED), speakers, and/or the like. As will be appreciated, the type of input devices 770 and output devices 715 may depend on the type of rover station 110 with which the input devices 770 and output devices 715 are integrated.

The rover station 110 may also include a wireless communication interface 730, which may comprise without limitation a modem, a network card, an infrared communication device, a wireless communication device, and/or a chipset (such as a Bluetooth® device, an IEEE 702.11 device, an IEEE 702.15.4 device, a Wi-Fi device, a WiMAX™ device, a Wide Area Network (WAN) device and/or various cellular devices, etc.), and/or the like, which may enable the rover station 110 to communicate via the networks described above with regard to FIG. 1. The wireless communication interface 730 may permit data and signaling to be communicated (e.g. transmitted and received) with a network, for example, via WAN access points, cellular base stations and/or other access node types, and/or other network components, computer systems, and/or any other electronic devices described herein. The communication can be carried out via one or more wireless communication antenna(s) 732 that send and/or receive wireless signals 734. The antenna(s) 732 may comprise a one or more discrete antennas, one or more antenna arrays, or any combination.

Depending on desired functionality, the wireless communication interface 730 may comprise separate transceivers, a separate receiver and transmitter, or any combination of transceivers, transmitters, and/or receivers to communicate with base stations and other terrestrial transceivers, such as wireless devices and access points. As previously noted, the rover station 110 may communicate with different data networks that may comprise various network types, which can be achieved using the wireless communication interface 730. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX™ (IEEE 702.16) network, and so on. A CDMA network may implement one or more radio access technologies (RATs) such as CDMA2000®, WCDMA, and so on. Cdma2000 includes IS-95, IS-2000, and/or IS-856 standards. A TDMA network may implement GSM, Digital Advanced Mobile Phone System (D-AMPS), or some other RAT. An OFDMA network may employ LTE™, LTE Advanced, 5G NR, and so on. 5G NR, LTE, LTE Advanced, GSM, and WCDMA are described in documents from the Third Generation Partnership Project (3GPP™) Cdma2000® is described in documents from a consortium named “3rd Generation Partnership Project 2” (3GPP2). 3GPP™ and 3GPP2 documents are publicly available. A WLAN may also be an IEEE 702.11x network, and a wireless personal area network (WPAN) may be a Bluetooth® network, an IEEE 702.15x, or some other type of network. The techniques described herein may also be used for any combination of WWAN, WLAN and/or WPAN.

The rover station 110 can further include sensor(s) 740. Sensors 740 may comprise, without limitation, one or more inertial sensors and/or other sensors (e.g., accelerometer(s), gyro scope(s), camera(s), magnetometer(s), altimeter(s), microphone(s), proximity sensor(s), light sensor(s), barometer(s), and the like), some of which may be used to complement and/or facilitate the position fix of the rover station 110 described herein, in some instances.

Embodiments of the rover station 110 may also include a GNSS receiver 780 capable of receiving signals 784 from one or more GNSS satellites (e.g., SVs 140) as described herein using an antenna 782 (which could be the same as antenna 732). As previously described GNSS receiver 780 that can take measurements to determine a position fix for the rover station 110, using from RF signals from GNSS SVs (e.g., SVs 140 of FIG. 1) of one or more GNSS constellations, and DGNSS and/or RTK service data provided by a DGNSS/RTK service provider. In some embodiments, the GNSS receiver 780 may comprise an MCMF receiver. Moreover, the GNSS receiver 780 can be used with various augmentation systems (e.g., SBAS) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

The rover station 110 may further include and/or be in communication with a memory 760. The memory 760 may comprise a machine- or computer-readable medium, which can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 760 of the rover station 110 also can comprise software elements (not shown in FIG. 7), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 760 that are executable by the rover station 110 (and/or processing unit(s) 710 or DSP 720 within rover station 110). In an aspect, then, such code and/or instructions can be used to configure and/or adapt a general purpose computer (or other device) to perform one or more operations in accordance with the described methods.

FIG. 8 is a block diagram of various hardware and software components of a base station 800, according to an embodiment, which can be utilized as described herein above (e.g., in association with FIGS. 1-7). For example, the base station 120 can perform the actions of the base station 120 illustrated in FIG. 1, the methods of FIGS. 4 and 6, and/or similar functions. It should be noted that FIG. 8 is meant only to provide a generalized illustration of various components, any or all of which may be utilized as appropriate.

The base station 800 is shown comprising hardware elements that can be electrically coupled via a bus 805 (or may otherwise be in communication, as appropriate). The hardware elements may include a processing unit(s) 810 which can include without limitation one or more general-purpose processors, one or more special-purpose processors (such as DSP chips, graphics acceleration processors, ASICs, and/or the like), and/or other processing structure or means. As shown in FIG. 8, some embodiments may have a separate DSP 820, depending on desired functionality. Location determination and/or other determinations based on wireless communication may be provided in the processing unit(s) 810 and/or wireless communication interface 830 (discussed below), according to some embodiments. The base station 800 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station further comprises a GNSS receiver 870 capable taking measurements of signals 882 received using an antenna 884 from one or more GNSS satellites (e.g., SVs 140), to obtain an ionosphere-free carrier phase combination, as described herein (e.g., measurements taken at blocks 410 and 430 of FIG. 4 and/or blocks 610 and 620 of FIG. 6). As such, the GNSS receiver 870 may comprise an MCMF receiver. As previously described this measurement information may be included as part of the service data (e.g., RTK and/or DGNSS service data) sent by the service provider to a rover station 110. The base station 120 may therefore provide this data to a service provider, which can include the measurement data, along with a known location of the base station, in the service data sent to the rover station 110.

The base station 800 may also include a network interface 880, which can include support of wireless and/or wireline communication technologies. The network interface 880 may include a modem, network card, chipset, and/or the like. Depending on desired functionality, the network interface 730 may comprise separate transceivers, a separate receiver and transmitter, or any combination of transceivers, transmitters, and/or receivers, which may be coupled with one or more input and/or output communication interfaces to permit data to be exchanged with a network (e.g., the data communication network 150), communication network servers, computer systems, and/or any other electronic devices described herein. As such, this can include any of a variety of wireless technologies (e.g., such as those described with regard to the wireless communication interface 730 of FIG. 7), and/or wired technologies.

In many embodiments, the base station 800 will further comprise a memory 860. The memory 860 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 860 of the base station 800 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the base station 800 (and/or processing unit(s) 810 or DSP 820 within base station 800). In an aspect, then, such code and/or instructions can be used to configure and/or adapt a general purpose computer (or other device) to perform one or more operations in accordance with the described methods.

It can be noted that, although GNSS receivers 780 and illustrated in FIGS. 8 and 870 in FIG. 8 are illustrated as components distinct from other components within a rover station 110 or base station 120, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processing units, such as processing unit(s) 710 or 810, DSP 720 or 820, and/or a processing unit within the wireless communication interface 730 (e.g., in a modem). A GNSS receiver may optionally also include a positioning engine, such as those described herein, which can use GNSS measurements from the measurement engine to determine a position of the GNSS receiver. The positioning engine may also be executed by one or more processing units, such as processing unit(s) 710 or 810, DSP 720 or 820.

FIG. 9 is a block diagram of an embodiment of a computer system 900, which may be used, in whole or in part, to provide the functions of the service provider server 160 and/or other computer systems described herein. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner. In addition, it can be noted that components illustrated by FIG. 9 can be localized to a single device and/or distributed among various networked devices, which may be disposed at different geographical locations.

The computer system 900 is shown comprising hardware elements that can be electrically coupled via a bus 905 (or may otherwise be in communication, as appropriate). The hardware elements may include processing unit(s) 910, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 900 also may comprise one or more input devices 915, which may comprise without limitation a mouse, a keyboard, a camera, a microphone, and/or the like; and one or more output devices 920, which may comprise without limitation a display device, a printer, and/or the like.

The computer system 900 may further include (and/or be in communication with) one or more non-transitory storage devices 925, which can comprise, without limitation, local and/or network accessible storage, and/or may comprise, without limitation, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 900 may also include a communication interface 930, which may comprise and software components configured to wireless or wired technologies. Wired technologies may include Ethernet, coaxial communications, universal serial bus (USB), and the like. The wireless communication may comprise 5G, LTE, and/or any of the other wireless technologies previously described (e.g., in relation to wireless communication interface 730 of FIG. 7). Thus the communications subsystem 930 may comprise a modem, a network card (wireless or wired), an infrared communication device, a wireless communication device, and/or a chipset, and/or the like, which may have separate transceivers, a separate receiver and transmitter, or any combination of transceivers, transmitters, and/or receivers which may enable the computer system 900 to communicate on any or all of the communication networks described herein (e.g., data communication network 150) to any device on the respective network, including the rover station 110, base station 120, other computer systems, and/or any other electronic devices described herein. Hence, the communications subsystem 930 may be used to receive and send data as described in the embodiments herein.

In many embodiments, the computer system 900 will further comprise a working memory 935, which may comprise a RAM or ROM device, as described above. Software elements, shown as being located within the working memory 935, may comprise an operating system 940, device drivers, executable libraries, and/or other code, such as one or more applications 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as computer system 900. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “generating,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device or system is capable of manipulating or transforming signals, typically represented as physical electronic, electrical, or magnetic quantities within memories, registers, or other information storage devices, transmission devices, or display devices of the special purpose computer or similar special purpose electronic computing device or system.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

1. A method of determining a bias in a location of a base station of a satellite-based differential positioning system, the method comprising:
obtaining a first Global Navigation Satellite System (GNSS) measurement taken by a GNSS receiver of the base station at a first time, wherein the first GNSS measurement comprises an ionosphere-free carrier phase combination;
obtaining a second GNSS measurement taken by the GNSS receiver of the base station at a second time, wherein the second GNSS measurement comprises an ionosphere-free carrier phase combination; and
determining the bias in the location of the base station based at least in part on a difference between the first GNSS measurement and the second GNSS measurement.

2. The method of claim 1, further comprising providing information of indicative of the bias in the location of the base station to the base station, a rover station, or a server, wherein the information of indicative of the bias in the location of the base station comprises:
the bias in the location of the base station,
a corrected position of the base station, based on the bias in the location of the base station,
or both.

3. The method of claim 1, further comprising:
conducting a between-satellite single difference to obtain one or more correction terms for one or more errors in the first GNSS measurement, the second GNSS measurement, or both, related to receiver clock, GNSS inter/intra frequency and constellation biases, or receiver phase center variation effect, or any combination thereof;
wherein determining the bias in the location of the base station is further based at least in part on the one or more correction terms.

4. The method of claim 1, wherein the method is performed by the base station, a rover station, or a computer server.

5. The method of claim 1, wherein a length of time between when the first GNSS measurement is taken and when the second GNSS measurement is taken is 15 minutes or greater.

6. The method of claim 1, further comprising adjusting a GNSS position fix of a rover station, based at least in part on the determined bias in the location of the base station, wherein the GNSS position fix of the rover station is based on service data from the base station.

7. The method of claim 1, wherein the satellite-based differential positioning system is configured to send service data associated with the base station to one or more rover stations, the service data including the first GNSS measurement and the second GNSS measurement.

8. The method of claim 7, wherein the service data comprises RTK service data or DGNSS service data.

9. A device comprising:
a transceiver;
a memory; and
one or more processing units communicatively coupled with the memory and transceiver, and configured to:
obtain a first Global Navigation Satellite System (GNSS) measurement taken by a GNSS receiver of a base station at a first time, wherein the first GNSS measurement comprises an ionosphere-free carrier phase combination;
obtain a second GNSS measurement taken by the GNSS receiver of the base station at a second time, wherein the second GNSS measurement comprises an ionosphere-free carrier phase combination; and
determine the bias in the location of the base station based at least in part on a difference between the first GNSS measurement and the second GNSS measurement.

10. The device of claim 9, wherein the one or more processing units communicatively coupled are further configured to provide information of indicative of the bias in the location of the base station to the base station, a rover station, or a computer server, wherein the information of indicative of the bias in the location of the base station comprises:
the bias in the location of the base station,
a corrected position of the base station, based on the bias in the location of the base station,
or both.

11. The device of claim 9, wherein the one or more processing units communicatively coupled are further configured to:
conduct a between-satellite single difference to obtain one or more correction terms for one or more errors in the first GNSS measurement, the second GNSS measurement, or both, related to receiver clock, GNSS inter/intra frequency and constellation biases, or receiver phase center variation effect, or any combination thereof;
wherein determining the bias in the location of the base station is further based at least in part on the one or more correction terms.

12. The device of claim 9, wherein the device comprises the base station, a rover station, or a computer server.

13. The device of claim 9, wherein the one or more processing units communicatively coupled are further configured to obtain the first GNSS measurement and the second GNSS measurement such that a length of time between when the first GNSS measurement is taken and when the second GNSS measurement is taken is 15 minutes or greater.

14. The device of claim 9, wherein the one or more processing units communicatively coupled are further configured to adjust a GNSS position fix of a rover station, based at least in part on the determined bias in the location of the base station, wherein the GNSS position fix of the rover station is based on service data from the base station.

15. An apparatus comprising:
means for obtaining a first Global Navigation Satellite System (GNSS) measurement taken by a GNSS receiver of a base station at a first time, wherein the first GNSS measurement comprises an ionosphere-free carrier phase combination;
means for obtaining a second GNSS measurement taken by the GNSS receiver of the base station at a second time, wherein the second GNSS measurement comprises an ionosphere-free carrier phase combination; and
means for determining the bias in the location of the base station based at least in part on a difference between the first GNSS measurement and the second GNSS measurement.

16. The apparatus of claim 15, further comprising means for providing information of indicative of the bias in the location of the base station to the base station, a rover station, or a computer server, wherein the information of indicative of the bias in the location of the base station comprises:
the bias in the location of the base station,
a corrected position of the base station, based on the bias in the location of the base station,
or both.

17. The apparatus of claim 15, further comprising:
means for conducting a between-satellite single difference to obtain one or more correction terms for one or more errors in the first GNSS measurement, the second GNSS measurement, or both, related to receiver clock, GNSS inter/intra frequency and constellation biases, or receiver phase center variation effect, or any combination thereof;
wherein determining the bias in the location of the base station is further based at least in part on the one or more correction terms.

18. The apparatus of claim 15, wherein the apparatus comprises the base station, a rover station, or a computer server.

19. The apparatus of claim 15, further comprising means for ensuring a length of time between when the first GNSS measurement is taken and when the second GNSS measurement is taken is 15 minutes or greater.

20. The apparatus of claim 15, further comprising means for adjusting a GNSS position fix of a rover station, based at least in part on the determined bias in the location of the base station, wherein the GNSS position fix of the rover station is based on service data from the base station.

21. (canceled)
